(19) United States
(12) Patent Application Publication
(10) Pub. No.: US 2015/0112585 A1
(43) Pub. Date: Apr. 23, 2015

(54) Communication System

(71) Applicant: Quicken Loans, Inc., Livonia, MI (US)

(72) Inventors: Travis C. Knepper, Woodville, OH (US); Ryan Robert Kukla, Lake Orion, MI (US); Joseph Lee Colburn, Clawson, MI (US); Kriser Gellci, Grosse Pointe, MI (US); Michael Dickman, Farmington Hills, MI (US); Donald James Ward, Tecumseh (CA)

(73) Assignee: Quicken Loans, Inc., Livonia, MI (US)

(21) Appl. No.: 14/060,258

(22) Filed: Oct. 22, 2013

(51) Int. Cl. G01C 21/34; G06Q 30/02

(52) U.S. Cl. CPC G01C 21/34; G06Q 30/0266
USPC 701/410; 701/522

(57) ABSTRACT

A transit system including a system data processor in communication with a driver data processor of a driver electronic device and a rider data processor of a rider electronic device. The system data processor receives vehicle information of a vehicle from the driver. data processor. The vehicle information includes a vehicle route and a geolocation of the vehicle. The system data processor receives a geolocation of a rider electronic device from the rider data processor, and sends the vehicle information and advertisement information over a communication network to the rider data processor. The advertisement information is based on the vehicle information and the geolocation of the rider electronic device.

### TECHNICAL FIELD

This disclosure relates to communication systems, such as a transportation communication system between drivers and riders via a web-based application on a mobile computing device.

### BACKGROUND

Mobile devices, such as smartphones, tablet PCs, cellular telephones, portable digital assistants and other handheld devices have become widespread and essential in personal and business use. Mobile devices were mainly used for voice communication, but recently they have become a reliable source for performing a range of business and personal tasks. The mobile devices are useful to obtain information by either making a phone call to an information center or accessing the internet and inputting a search query for obtaining the requested information. The information requested may be information relating to a location of a restaurant, hotel, shopping center, or any other information, such as customer reviews or hours of operation. Some devices include a global positioning system (GPS) that provides the user with their location on an electronic map being displayed on the GPS. In addition, some devices allow the user to enter a specific address or search for a specific location and the mobile device navigates the user to the specific location.

Some smartphones are light in weight and include a display with either a touch input or a miniature keyboard for allowing the user to quickly type emails, text messages, or search ques. Smartphones have become accessible, widely used, and greatly relied on for various tasks (e.g., calendar, maps, navigation, travel, etc. Moreover, web-based applications may now accommodate tasks capable of being performed on a smartphone. Web-based applications are programs designed to be used entirely within a browser and may allow a user to create documents, edit pictures, listen to music, and shop at a specific store without installing complicated software. Other examples of web-based applications include calendars, phonebooks, maps, navigation, gaming, etc.

### SUMMARY

One aspect of the disclosure provides a transit system including a system data processor in communication with a driver data processor of a driver electronic device (e.g., computer, portable electronic device, smartphone, tablet PC, cellular telephone, portable digital assistant) and a rider data processor of a rider electronic device (e.g., computer, portable electronic device, smartphone, tablet PC, cellular telephone, portable digital assistant). The system data processor receives vehicle information (e.g., a vehicle route and a geolocation of the vehicle) of a vehicle from the driver data processor. The system data processor receives a geolocation of a rider electronic device from the rider data processor, and sends the vehicle information and advertisement information over a communication network to the rider data processor. The advertisement information is based on the vehicle information and the geolocation of the rider electronic device.

Implementations of the disclosure may include one or more of the following Features. In some implementations, the system data processor determines the advertisement information based on a rider profile associated with a rider using the rider electronic device. The rider profile includes at least one of a rider route history, a rider travel time history, a predicted rider route, a predicted ride time, or consumption preferences. Additionally, the system data processor determines the advertisement information based on a correlation between attributes of available advertisement offers and attributes of the rider profile. The attributes of available advertisement offers includes at least one of an offer location, an offer time, an offer price, or an offer phone number. The attributes of the rider profile may include at least one of a rider location, a rider time of travel, a rider budget, rider transportation preferences, or rider advertisement preferences.

In some examples, the vehicle information further includes a service status being an in-service status or an out-of service status. When the service status is out-of-service, the system data processor receives a message associated with the out-of service status and an out-of service time indicating a duration of the out-of-service status. The vehicle information may include a rider count of the vehicle. The rider count being a number of riders on the vehicle or a rider status indicating that the vehicle has zero riders or a maximum number of riders.

In some implementations, the system data processor communicates to the rider data processor or the driver data processor: map data for displaying an interactive map; vehicle route representation data for overlaying on the interactive map a representation of the vehicle route; and at least one of vehicle representation data for overlaying on the interactive map a representation of the vehicle or rider representation data for overlaying on the interactive map a representation of the rider electronic device. The advertisement information may include advertisement representation data for overlaying on the interactive map a representation of the advertisement information along the vehicle route or at least near a location of an establishment associated with the advertisement information. Additionally, the establishment may be located along at least the vehicle route, a predicted rider route for the rider electronic device, or a predicted destination of the rider electronic device based on a riding history associated with a rider using the rider electronic device.

In some implementations, the system data processor sends over a communication network to the rider data processor historical data. The historical data includes at least one of an average vehicle route time based on a past time of day, an average vehicle route time based on a current time of day, a rider route history based on a time of day, a rider retrieval history of offered advertisements, or a rider count based on a time of day.

The system data processor may periodically receive the respective geolocation of the rider electronic device and the driver electronic device, for example, after a threshold period of time. Additionally or alternatively, the system data processor sends to the rider data processor an estimated time of arrival of the vehicle at either the rider electronic device along the vehicle route or a designated vehicle stop along the vehicle route.

Another aspect of the disclosure provides a method of communication within a transit system. The method includes receiving, at a computing device, vehicle information (e.g., vehicle route and geolocation) of a vehicle. The method also includes receiving, at the computing device, a geolocation or transportation preference of a rider electronic device, and sending, from the computing device, the vehicle information and advertisement information over a communication network to the rider electronic device, the advertisement information based on the vehicle information and the geolocation or transportation preference of the rider electronic device.

The method may include determining the advertisement information based on a rider profile associated with a rider using the rider electronic device. The rider profile includes at least one of a rider route history, a rider travel time history, a predicted rider route, a predicted ride time, or consumption preferences. In some examples, the advertisement information may be based on a correlation between attributes of available advertisement offers and attributes of the rider profile. The attributes of available advertisement offers may include at least one of an offer location, an offer time, an offer price or value, or an offer phone number; while the attributes of the rider profile may include at least one of a rider location, a rider time of travel, a rider budget, or rider advertisement preferences.

In some implementations, the vehicle information further includes a service status, the service status being an in-service status or an out-of service status. The vehicle information may also include a rider count of the vehicle, the rider count being a number of riders on the vehicle or a rider status indicating that the vehicle has zero riders or a maximum number of riders.

The method may further include sending from the computing device over a communication network to the rider electronic device: map data for displaying an interactive map; vehicle route representation data for overlaying on the interactive map a representation of the vehicle route; and vehicle representation data for overlaying on the interactive map a representation of the vehicle. Additionally or alternatively, the method may include sending from the computing device over a communication network to the rider electronic device: map data for an interactive map; vehicle route representation data for overlaying on the interactive map a representation of the vehicle route; and rider representation data for overlaying on the interactive map a representation of the rider electronic device. Additionally or alternatively, the method may also include sending, from the computing device over a communication network to the rider electronic device, historical data including at least one of an average vehicle route time based on a past time of day, an average vehicle route time based on a current time of day, a rider route history based on a time of day, a rider retrieval history of offered advertisements, or a rider count based on a time of day.

Another aspect of the disclosure provides a method of communication within a transit system. The method includes receiving, at least periodically at a computing device, vehicle information (e.g., vehicle route and a geolocation) of a vehicle. The method includes electronically displaying on a display of the computing device: an interactive map; a vehicle route representation on the interactive map; and a real-time vehicle representation on the interactive map. The method also includes sending, at least periodically from the computing device, a geolocation of the computing device over a communication network to a service provider; and receiving, at least periodically at the computing device, advertisement information from the service provider based on the vehicle information and the geolocation of the computing device.

In some examples, the method further includes accessing a rider profile of a rider using the computing device. The rider profile including at least one of a rider route history, a rider travel time history, a predicted rider route, a predicted ride time, or consumption preferences. The advertisement information may be based on a correlation between attributes of available advertisement offers and attributes of the rider profile. The attributes of available advertisement offers may include at least one of an offer location, an offer time, an offer price, or an offer phone number. In some examples, the attributes of the rider profile include at least one of a rider location, a rider time of travel, a rider budget, or rider advertisement preferences.

In some examples, the vehicle information further includes a service status, the service status being an in-service status or an out-of service status. Additionally or alternatively, the vehicle information may include a rider count of the vehicle the rider count being a number of riders on the vehicle or a rider status indicating that the vehicle has zero riders or a maximum number of riders.

Yet another aspect of the disclosure provides a portable electronic device. The portable electronic device includes a geolocation component, a data processor and a display. The geolocation component determines a geolocation of the portable electronic device. The data processor is in communication with the geolocation component and is configured to: receive vehicle information (e.g., a vehicle route and a geolocation) of the vehicle; send the geolocation of the portable electronic device over a communication network to a service provider; and receive advertisement information from the service provider based on the vehicle information and the geolocation of the computing device. The display is in communication with the data processor and displays a user interface. The user interface includes: a route selector; an interactive map; a route representation on the interactive map, the route representation corresponding to a route selected on the route selector; a real-time device representation on the interactive map at a location corresponding to the geolocation of the portable electronic device; at least one real-time vehicle representation on the interactive map of any vehicles associated the selected route; and an advertisement representation on the interactive map representative of the advertisement information.

In some examples, the advertisement representation is overlain on the interactive map along the selected vehicle route or at least near a location of an establishment associated with the advertisement information. The establishment may be located along at least the vehicle route, a predicted rider route for the rider electronic device, or a predicted destination of the rider electronic device based on a riding history associated with a rider using the rider electronic device. In some examples, the data processor accesses a rider profile of a rider using the portable electronic device. The rider profile includes at least one of a rider route history, a rider travel time history, a predicted rider route, a predicted ride time, or consumption preferences. The advertisement information may be based on a correlation between attributes of available advertisement offers and attributes of the rider profile. The attributes of available advertisement offers may include at least one of an offer location, an offer time, an offer price, or an offer phone number. The attributes of the rider profile may include at least one of a rider location, a rider time of travel, a rider budget, or rider advertisement preferences.

The portable vehicle information may include a service status, the service status being an in-service status or an out-of service status. Additionally or alternatively, the vehicle information may include a rider count of the vehicle, the rider count being a number of riders on the vehicle or a rider status indicating that the vehicle has zero riders or a maximum number of riders.

Yet another aspect of the disclosure provides a transit system that includes at least one driver electronic device and one rider electronic device, and a service provider device. Each electronic device (driver and rider) includes a data processor; a geolocation component in communication with the data processor and determining a geolocation of the electronic device; and a display in communication with the data processor and displaying a user interface. The user interface includes: a route selector; an interactive map; a route representation on the interactive map, the route representation corresponding to a route selected on the route selector; and a real-time device representation on the interactive map at a location corresponding to the geolocation of the electronic device. The service provider device includes a data processor in communication with the data processor of the driver electronic device and the data processor of the rider electronic device. The data processor of the service provider device receives vehicle information (e.g., vehicle route and geolocation) of a vehicle from the driver data processor. The data processor of the service provider device receives a geolocation of the rider electronic device from the rider data processor; and sends the vehicle information and advertisement information over a communication network to the rider data processor. The advertisement information is based on the vehicle information and the geolocation of the rider electronic device.

In some implementations, the display of each electronic device displays at least one real-time vehicle representation on the interactive map of any vehicles associated with any driver electronic devices on the selected route. In some examples, the data processor of the service provider determines the advertisement information based on a rider profile associated with a rider using the rider electronic device, the rider profile including at least one of a rider route history, a rider travel time history, a predicted rider route, a predicted ride time, or consumption preferences. The data processor of the service provider determines the advertisement information based on a correlation between attributes of available advertisement offers and attributes of the rider profile. The attributes of available advertisement offers may include at least one of an offer location, an offer time, an offer price, or an offer phone number. The attributes of the rider profile may include at least one of a rider location, a rider time of travel, a rider budget, or rider advertisement preferences. In some examples, the advertisement information includes advertisement representation data for overlaying on the interactive map a representation of the advertisement information along the vehicle route or at least near a location of an establishment associated with the advertisement information. The establishment may be located along at least the vehicle route, a predicted rider route for the rider electronic device, or a predicted destination of the rider electronic device based on a riding history associated with a rider using the rider electronic device.

Yet another aspect of the disclosure provides a method that includes receiving, at a computing device, a user profile including a geolocation of a user electronic device. The method includes sending, from the computing device, advertisement information of an advertisement provider (e.g., restaurant) over a communication network to the user (e.g., rider or driver) electronic device. The advertisement information is based on the user profile, and has one or more user selectable portions and includes an advertisement location. The method further includes receiving a selection of a user selectable portion from the user and associating a time and a geolocation with the selection. The method also includes storing the selectable portion of the advertisement information and associated time and geolocation of the selection in non-transitory memory of the computing device.

In some examples, the user profile includes at least one of a user route history, a user travel time history, a predicted user travel route, a predicted user travel time, consumption preferences, a user budget, user transportation preferences, or user advertisement preferences. The method further includes determining a distance between the geolocation associated with the selection of the user selectable portion and the advertisement location. When the distance is within a first threshold distance, the method includes charging the advertisement provider a first fee rate. When the distance is within a second threshold distance, the method includes charging the advertisement provider a second fee rate.

In some implementations, the method includes sending, from the computing device, advertisement information to the user electronic device based on the selection of a user selectable portion of the advertisement information and associated time and geolocation of the selection. in some examples, the user selectable portions include at least one of a name of the advertisement provider, hours of operation, an address, a uniform resource locator link to the address, an offer uniform resource locator ink, or a purchase uniform resource locator link.

Additionally or alternatively, the advertisement information may include multiple user selectable portions, tracking a conversion of the user when the user selects multiple user selectable portions of the advertisement information. Additionally or alternatively, the method may further include tracking a conversion of a user when the user executed a purchase operation through the advertisement information, or accepts an offer of the advertisement information.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an exemplary overview of the communication between a rider, driver and service provider.

FIG. 2 is a schematic view of an exemplary overview of the communication between drivers driving vehicles and the riders riding the vehicles.

FIG. 3 is a schematic view of an exemplary overview of the communication between the riders and drivers of different types of vehicles.

FIG. 4 is a schematic view of an exemplary driver application.

FIG. 5 is a schematic view of an exemplary interaction decision tree of a driver electronic device.

FIG. 6 is a schematic view of an exemplary log-in view of a driver application.

FIGS. 7A and 7B are schematic views of an exemplary driver home screen view.

FIG. 8 is a schematic view of an exemplary rider application.

FIG. 9 is a schematic view of an exemplary rider home screen view.

FIG. 10 is a schematic view of an exemplary driver settings screen view.

FIG. 11 is a schematic view of an exemplary detailed rider advertisement.

FIG. 12 is a schematic view of an exemplary overview of a correlation between attributes of a rider and attributes of an available advertisement.

FIG. 13 is a schematic view of an exemplary overview of the communication between a rider, driver and service provider.

FIG. 14 is a schematic view of an exemplary arrangement of operations for communicating between drivers driving vehicles and riders riding the vehicles.

FIG. 15 is a schematic view of an exemplary arrangement of operations for communicating between drivers driving vehicles and riders riding the vehicles.

FIG. 16 is a schematic view of an exemplary arrangement of operations for tracking user conversion.

Like reference symbols in the various drawings indicate like elements.

### DETAILED DESCRIPTION

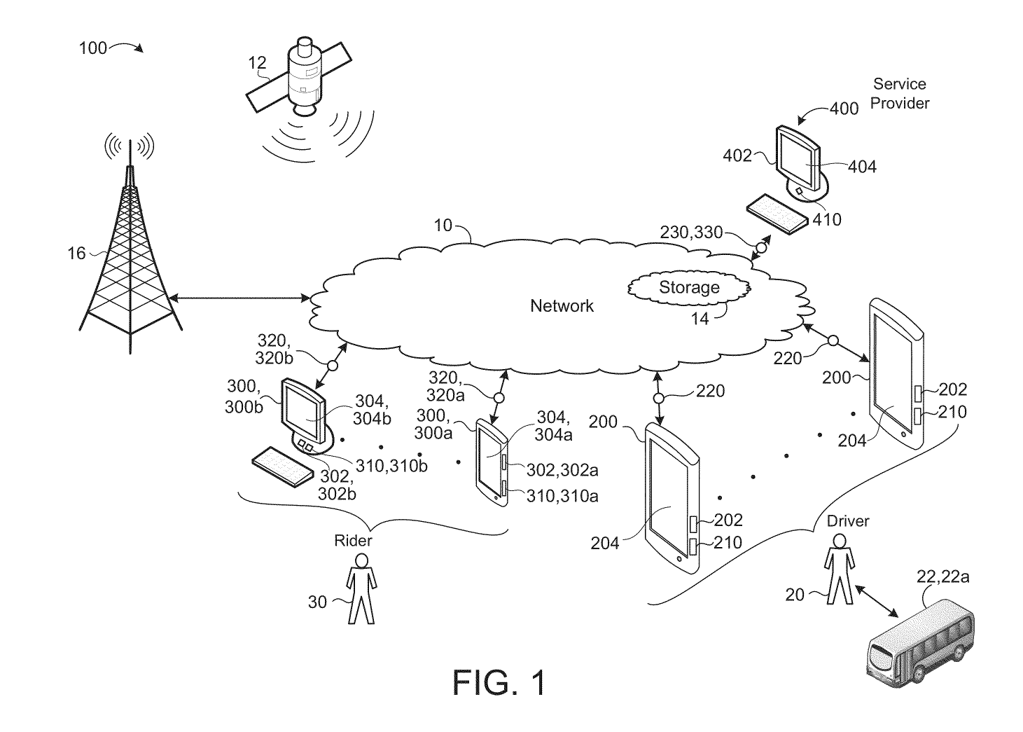

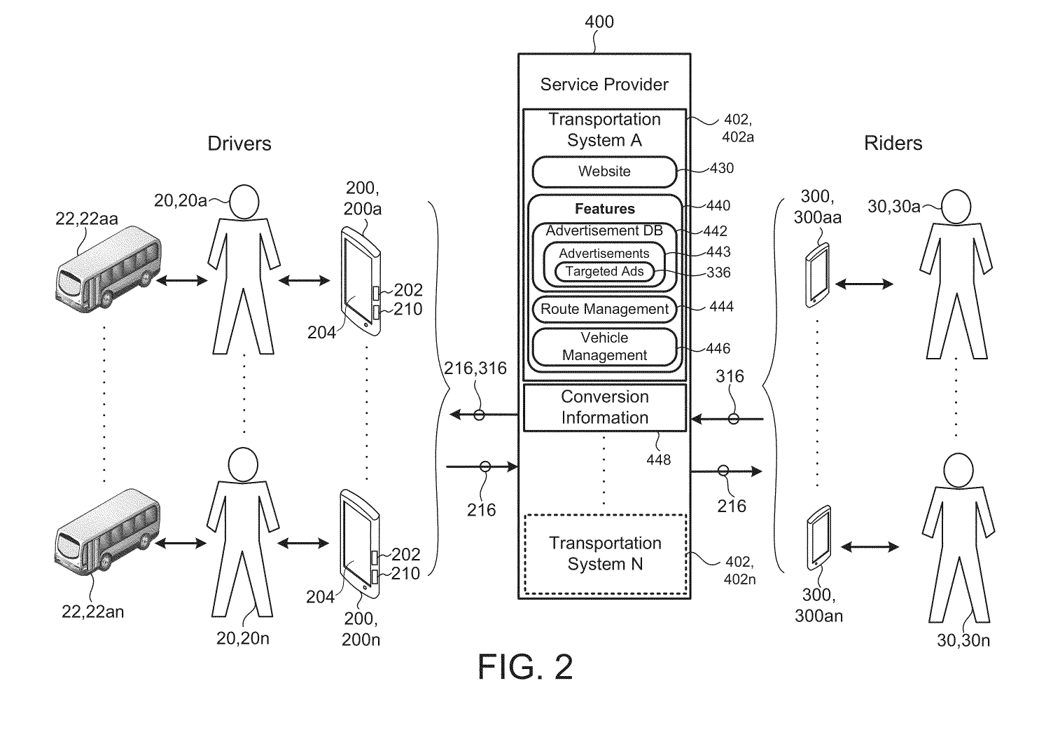

Referring to FIGS. 1 and 2, in some implementations, a transportation communication system 100 includes a network 10, a base station 16, and multiple terminals 200, 300, 400. The terminals 200, 300, 400 may include a driver terminal 200, a rider or user terminal 300, and a service provider terminal 400. Each terminal 200, 300, 400 may be a portable electronic device, such as a wireless device (e.g., cellular phone, smartphone, personal digital assistant, personal computer, a wireless pad) or any other device capable of sending and receiving information via the network 10. The portable electronic devices may each have a display 204, 304, 404. Each terminal may also have its respective non-transitory memory 210, 310, 410.

The network 10 may include any type of network that allows sending and receiving communication signals, such as a wireless telecommunication network, a cellular telephone network, a time division multiple access (TDMA) network, a code division multiple access (CDMA) network, Global system for mobile communications (GSM), a third generation (3G) network, fourth generation (4G) network, a satellite communications network, and other communication networks. The network 10 may include one or more of a Wide Area Network (WAN), a Local Area Network (LAN), and a Personal Area Network (PAN). In some examples, the network 10 includes a combination of data networks, telecommunication networks, and a combination of data and telecommunication networks. The terminals 200, 300, 400 communicate with the network 10 by sending and receiving signals (wired or wireless) via the base station 16. In some examples, the driver and rider terminals 200, 300 may be in communication with a global positioning system (GPS) satellite 12, global navigation satellite system (GNSS) or the like, for determining the position of the driver and rider terminals 200, 300. In some examples, the network 10 provides access to cloud computing resources, which may be elastic/on-demand computing and/or storage resources available over the network 10. The term ‘cloud’ services generally refers to a service performed not locally on a user's device, but rather delivered from one or more remote devices accessible via one or more networks 10. Since the driver or rider's devices 200, 300 do not need to know or learn the details of what is happening at the one or more remote devices, the service appears to be delivered from a ‘cloud’ from the perspective of the user's device. The drivers 20 and the riders 30 may access cloud storage 14 (e.g., non-transitory memory) via a web browser or a web-based application in communication to with the network 10 to access data relating to each user remotely stored by the cloud storage 14.

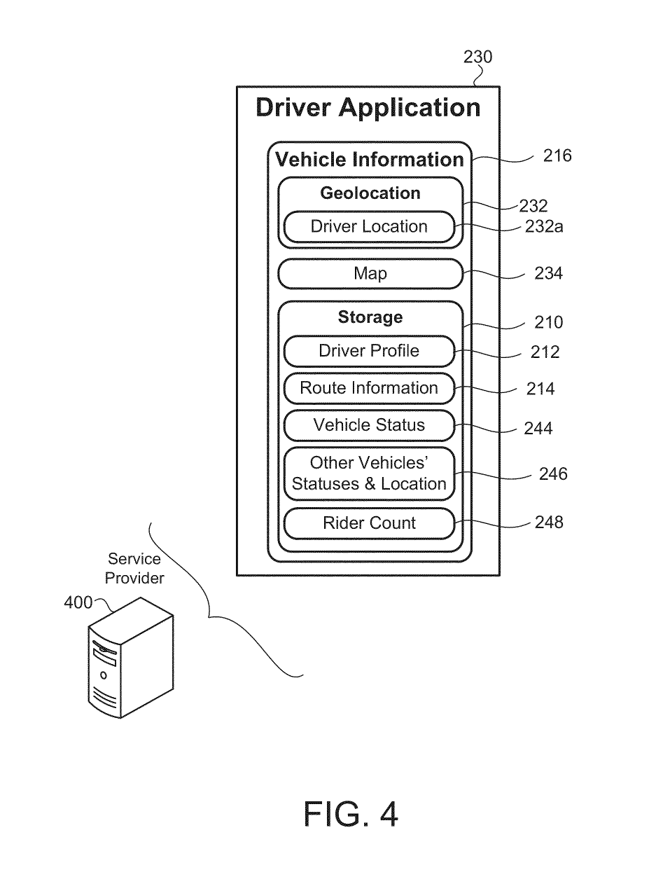

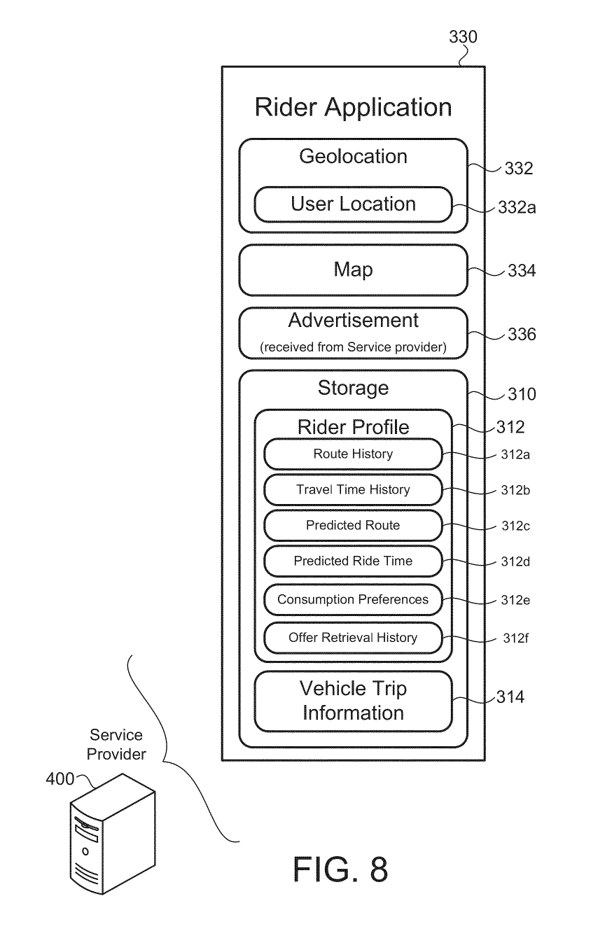

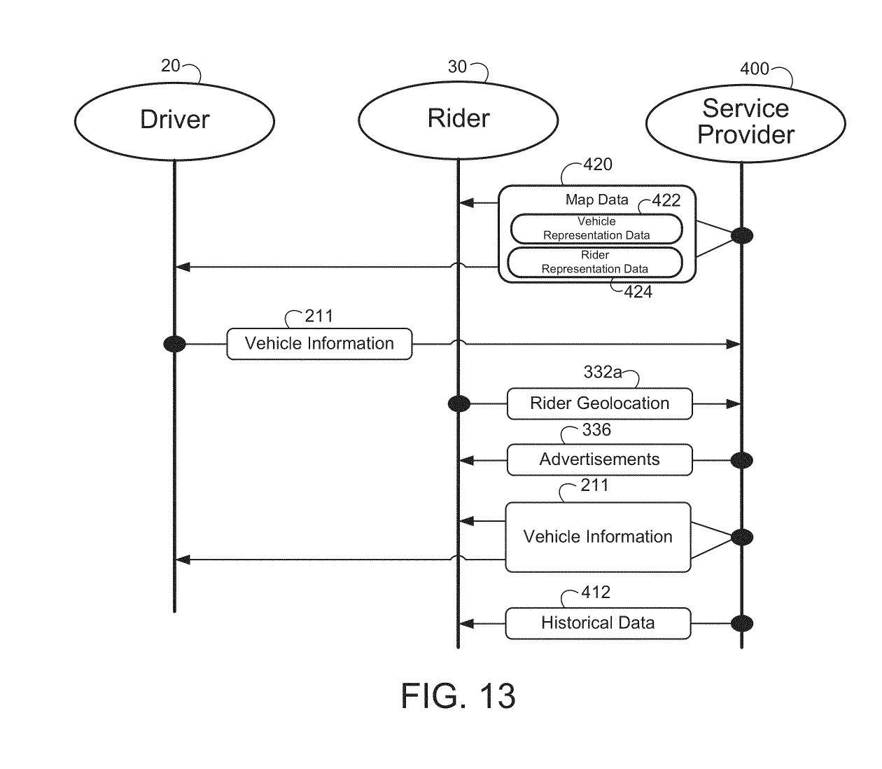

The service provider 400 may include a system data processor (e.g., computing device) 402 having a non-transitory memory 410. The service provider 400 provides the driver 20 with a driver application 230 (FIG. 4) for entering vehicle information 216 to be communicated via the network 10 to the riders 30. In addition, the service provider 400 provides the riders 30 with a rider application 330 (e.g., a mobile application 330a or a web-site application 330b) (FIG. 8) allowing the rider 30 to view the vehicle information 216 provided by the vehicle drivers 20. The user application 330 may retrieve user information 316, which may include, but is not limited to, user provided information or behavioral information captured by monitoring and/or tracking user location and behavioral trends to provide better information to the rider 30. In addition, the service provider 400 monitors the vehicle information 216 and the rider information 316 and populates historical data 412 (FIG. 13), which includes but is not limited to, an average vehicle route time based on a past time of day, an average vehicle route time based on a current time of day, a rider route history based on a time of day, a rider retrieval and interaction history of offered advertisements, or a rider count history based on a time of day. Therefore, the computing device 402 of the service provider 400 communicates with a driver data processor 202 of a driver electronic device 200 and a rider data processor 302 of a rider electronic device 300.

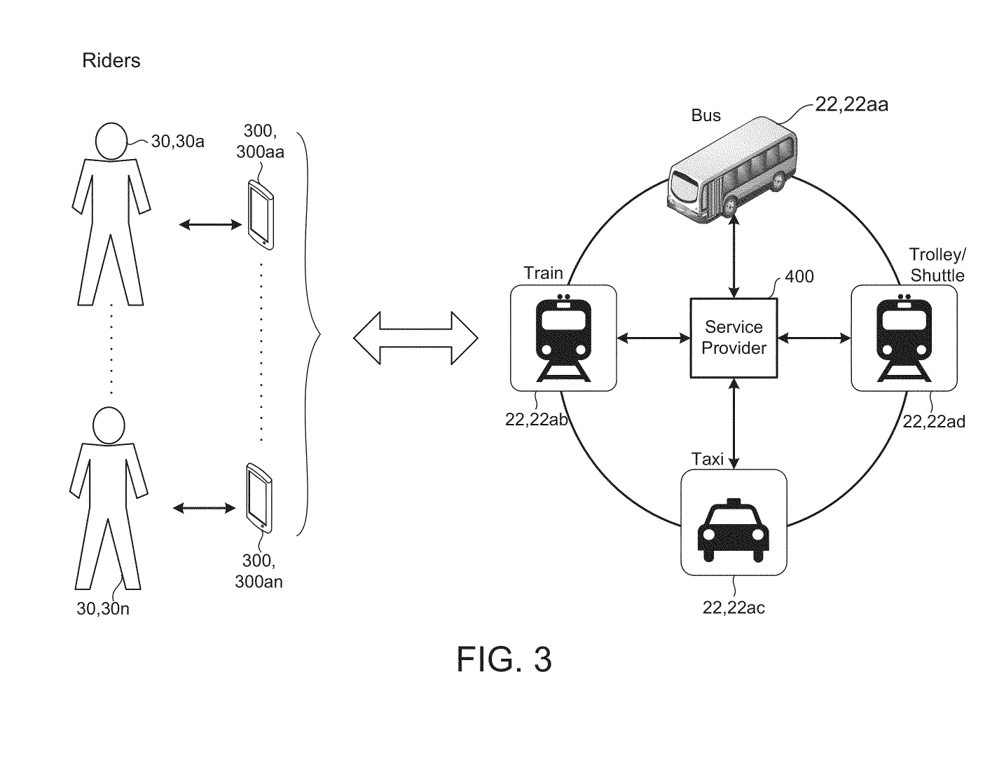

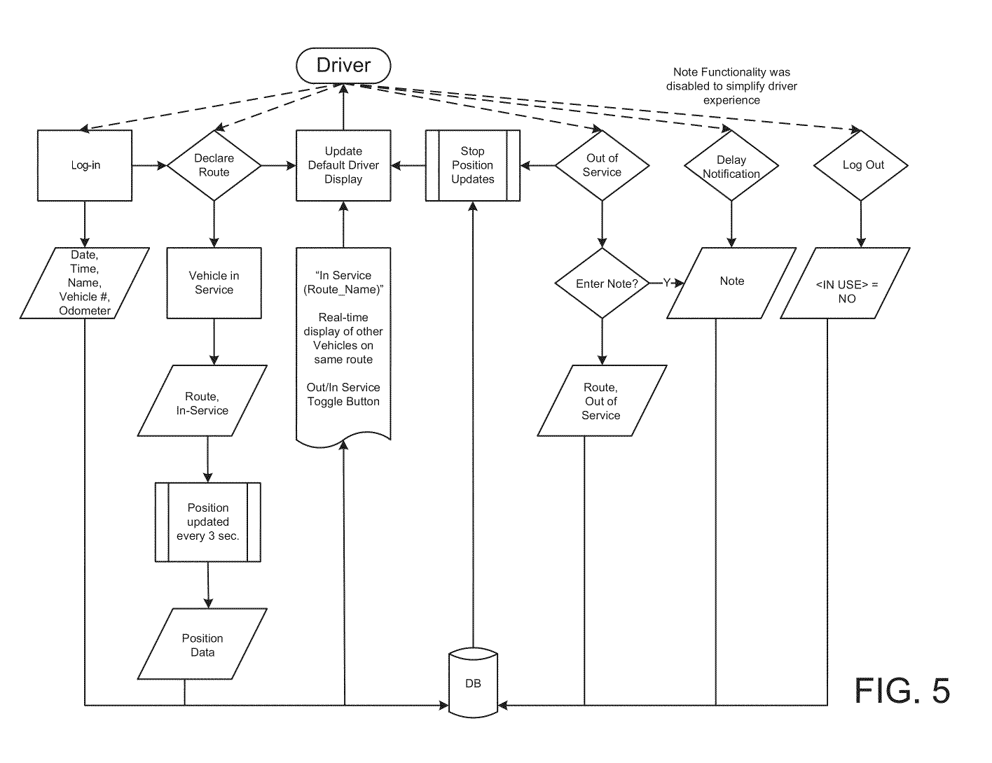

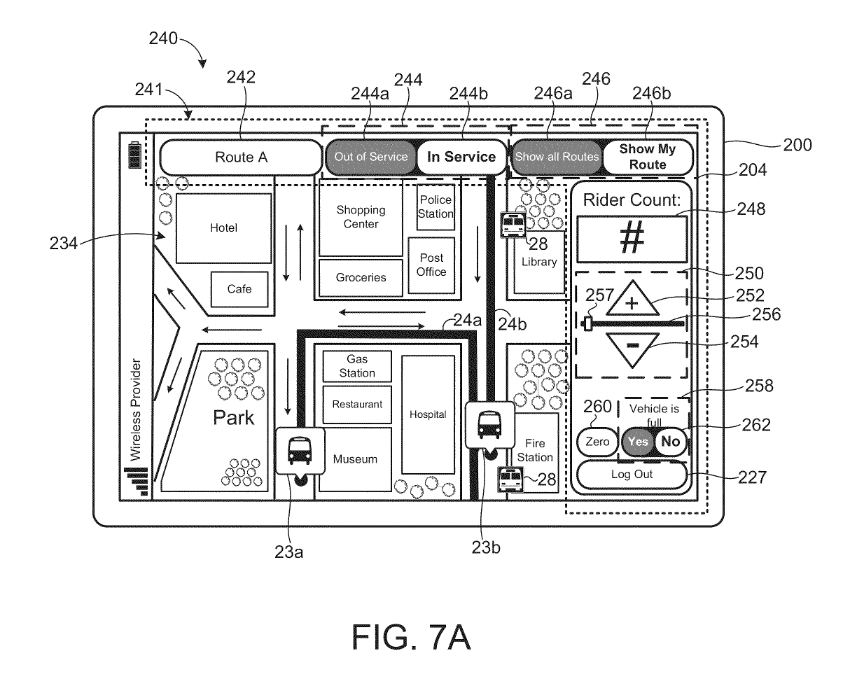

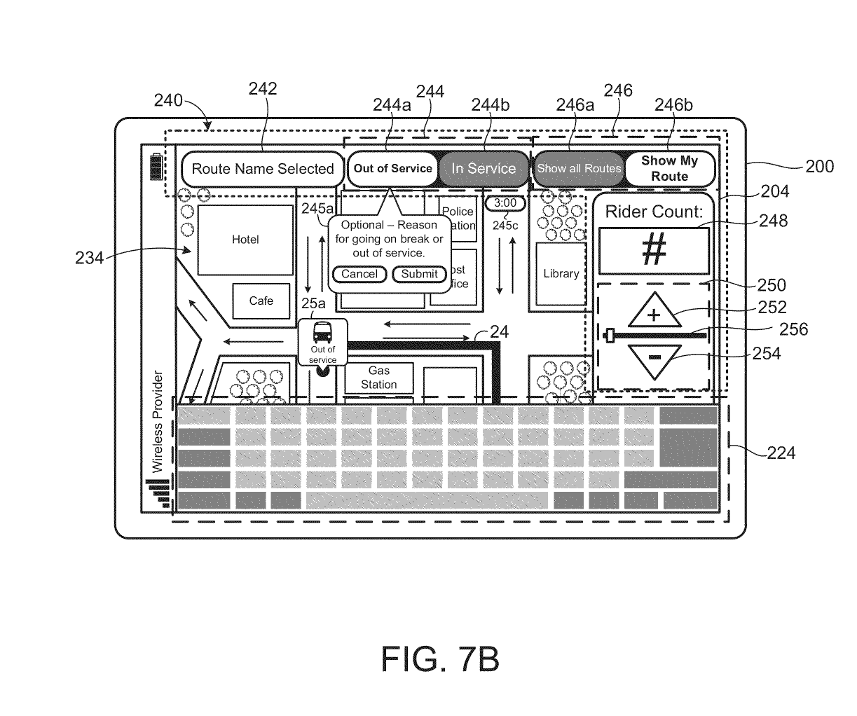

As shown in FIG. 2, the service provider 400 facilitates the exchange of information (vehicle information 216 and rider information 316) between the riders 30a-30n via their portable electronic devices 300aa-300an (or a website 300b) and the vehicle 22 drivers 20a-20n as each driver 20 is driving a respective vehicle 22 (e.g., bus 22aa-22an as shown in FIGS. 2 and 3) and manually updating vehicle information 216 via a portable electronic device 200a-200n associated with each vehicle 22. The exchanged information 216, 316 aids the rider 30 in planning their transportation arrangements and plan accordingly especially if the transportation vehicle 22 they are waiting for is behind schedule or is out of order. The exchanged information includes: (1) an interactive map 234, 334; (2) a location of one or more vehicles 22 and a route may be transposed upon the map 234, 334; (3) rider count 248 of the one or more vehicles 22; and (4) merchant/advertising information that may be proximate one or more anticipated drop-off location along the transit route (FIGS. 7A-9). The service provider 400 receives vehicle information 216 of a vehicle 22 driven by a driver 20 from the driver data processor 202. In addition, the service provider 400 receives rider information 316, which may include a geolocation and/or transportation preference of a rider electronic device 300 from the rider data processor 302. When the service provider 400 receives the information from drivers 20 and the riders 30, the service provider 400 sends the vehicle information 316 over the communication network 10 to the rider data processor 202. The service provider 400 also sends targeted advertisements 336 (FIG. 5) based on the vehicle information 216 and the geolocation and/or transportation preference of the rider electronic device 300.

The service provider 400 may modify the threshold time for retrieving and downloading driver and rider information 216, 316. In some examples, the service provider 400 considers several factors for determining an uploading rate and a downloading rate, which both may be changed. These factors may include but are not limited to, the amount of data and the number of database entries and information granularity. Additionally, the rate of retrieving driver information 216 may be different than the rate of retrieving rider information 316 because the service provider 400 needs accurate location of the driver 20 in comparison to the rider 20. Similarly, the rate of sending other vehicle and user information 216, 316 to the driver 20 may be different than the rate of sending information to the rider 30.

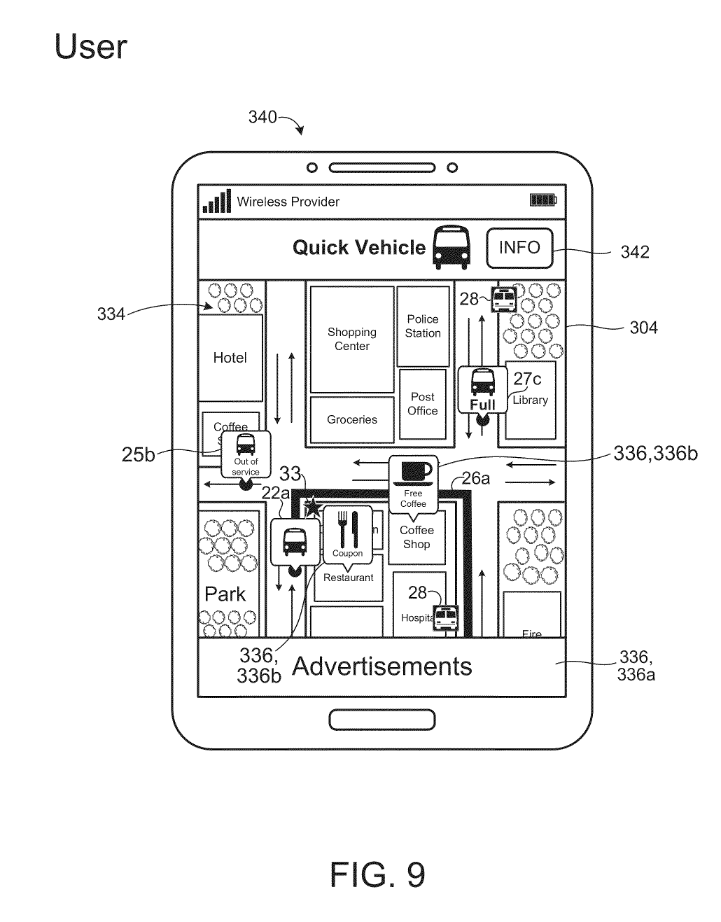

Referring to FIG. 3, in some implementations the service provider 400 may facilitate communication between the riders 30 and the drivers 20 of multiple transportation vehicles 22 such as, but not limited to, a bus 22aa, a metro or a train 22ab, a taxi or cab 22ac, and/or a trolley or shuttle bus 22ad. In some examples, the rider 30 may choose which mode of transportation to use based on the closest one to his/her current location 33 (FIG. 9) or based on an estimated time of arrival to the rider's 30 destination or hours of operation of the mode of transportation. For example, the metro or train 22ab may be closed after a certain time of day and the only available transportation is a taxi or a cab 22ac.

Referring back to FIG. 2, in some implementations, the service provider 400 provides additional features. These additional features 440 may be accessible by logging on to the service provider website 430 and providing a passcode or by using a mobile application (e.g., driver application 230 or rider application 330). The additional features 440 may include an advertisement database 442, which includes available advertisements 443, which allows the service provider 400 to update the targeted advertisements 336 (FIG. 9) sent to the riders 30 (described in details below). In some examples, the service provider 400 may specify push notifications to be sent to the riders 30 informing them that a vehicle 22 is running late, pickup location has been changed, etc. Another feature is the route management feature 444 for managing fleet vehicles 22, which allows the service provider 400 to create additional vehicle routes that are available for the drivers 20 to select when logging on the driver application 230. The service provider 400 may include a route name and/or a route color. In some examples, the service provider 400 may view route management information 444, which includes, but is not limited to, information relating to the route such as, the time it takes to complete the route, the time of day that requires the shortest time to complete the route versus the time of day that it takes the most time to complete the route. In some examples, the service provider 400 may manage the vehicles 22 and update or modify the route that they take from a first location to a second location. The route management feature 444 allows for the configuration and selection of the transportation routes and the viewable attributes (e.g., vehicle icons, route color, route name), in addition to viewing historical data reports for vehicles 22 and riders.

Another feature 440 may be the vehicle management feature 446, which allows the service provider 400 to view all the current vehicles 22 that are on the road within a relevant transportation system. In addition, the service provider 400 may filter which vehicles 22 to view. For example, a service provider 400 may want to view all the vehicles 22 that are out-of service or in-service. Moreover, the user 20 service provider 400 may filter the vehicles 22 that are out-of-service based on the time they have been out-of-service and read the comments that the other driver 20 added in the out-of-service field 245a indicating the reason the vehicle 22 is out-of-service.

The service provider 400 may filter the information that the additional features 440 provide based on historical data, which includes at least one of an average route time based on the time of day, a rider route history based on the time of day, a rider's retrieval history of and interactions with the advertisements offered, or the rider count based on the time of day.

In some examples, the service provider 400 may include one or more transportation systems 402; each transportation system 402 includes different transportation options, such as different vehicles 22, different routes, and different features. Each transportation system 402 has features dedicated to its drivers 20 or riders 30 that is not accessible to drivers 20 or riders 30 of another transportation system 402. For examples, a first transportation system 402 may include a shuttle bus 22ad for driving riders from a first building to a second building. A second transportation system 402 may include a bus 22aa driving its riders 30 through the city. Therefore, a rider 30 using the first transportation system 402 will not have access to the information that the second transportation system 402 provides and vice versa. Similarly, the advertisements 443 may be different for each transportation system 402. This application discusses a service provider having one transportation system 402; however, similar configurations are available for each additional transportation system 402.

With continued reference to FIGS. 1 and 2, in some implementations, the driver 20 may use a portable electronic device 200 to communicate driver information 216 to the rider 30 via the network 10 and the service provider 400. The driver 20 may download a driver application 230 provided by the service provider 400. The driver 20 may go to a website provided by the service provider 400 and request from the service provider 400 that the driver application 230 be downloaded on the driver's portable electronic device 200. In some examples, the driver's portable electronic device 200 includes the driver application 230, which may be stored on the portable electronic device 200 having non-transitory memory 210.

Referring to FIG. 4, in some implementations, the driver application 230 includes several features, such as geolocation services 232 (e.g., the driver's location 232a), an interactive map 234, non-transitory memory 210 (e.g., driver profile 212, which includes the driver identification number 221a and any settings associated with the driver 20), route information 214 (e.g., the planned route that the vehicle 22 will take), vehicle status 244 (e.g., in-service, out-of-service, or full), other vehicles statuses and location 246 (e.g., in-service, out-of-service, or full on the interactive map 234), and rider count 248. The driver application 230 may include other features not listed such as, traffic information and/or weather information.

Geolocation services 232 identify a geographic location 232a of an object (e.g., mobile computing device 402 or computer terminal). Geolocation services 232 use a positioning system to determine a specific location 232a, such as, a street intersection or an address rather than a set of geographic coordinates. Internet and computer geolocation may be performed by associating a geographic location with the internet protocol address, machine access control (MAC) address, radio frequency identifier (REID), hardware embedded article or production number, embedded software number, Wi-Fi positioning system, device GPS coordinates, or other information.

In some examples, the geolocation services 232 include a location-based service (LBS), which is an information service for providing specific controls for location and time data. LBS is generally used in social networking and as entertainment services. LBS includes services for identifying a location of a person or an object. Some examples include locating a friend, a family member or an employee or locating the nearest restaurant, park, or hotel. In some examples, LBS is used for mobile commerce and for targeting users in a specific location with advertisements and coupons of businesses in the user's vicinity based on the user's location. LBS services may include personalized weather services and news services.

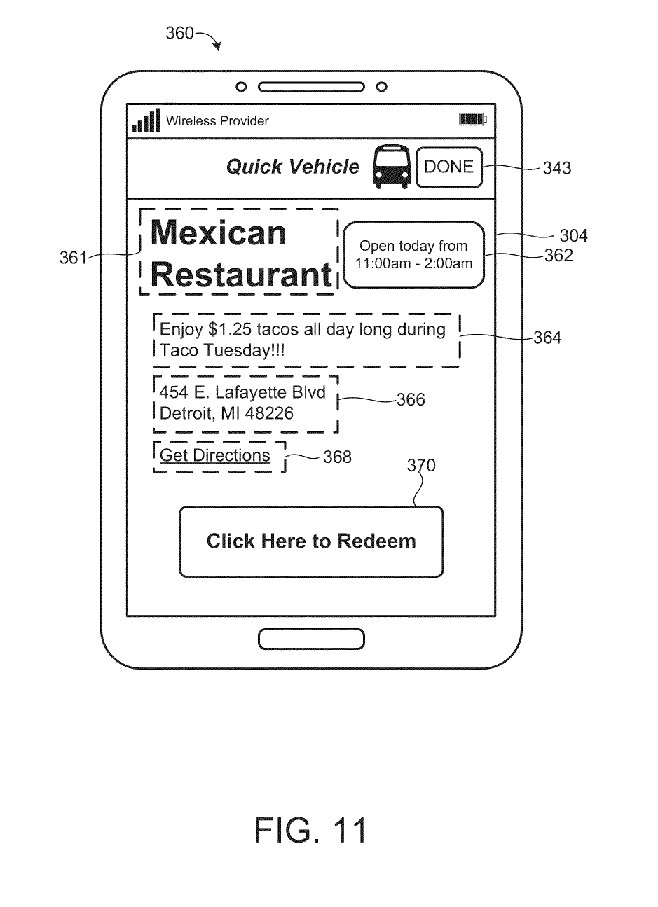

In some examples, where a driver 22 is not needed to drive the vehicle 22, i.e., a driverless vehicle such as airport transportation or autonomous vehicles, the driver application 230 may be installed and configured to transmit the geolocation 232 of the vehicle 22. In such instances, the driver application 230 may be configured to automatically provide a rider count 248 without a driver 20 to manually increase or decrease the driver count 248. In this example, one or more driver's portable electronic devices 200 are placed in a location on the vehicle 22 where the riders 30 may view the display 204 of the portable device 200. Different riders 30 may simultaneously interact with the driver application 230 on different displays 304 and in a different manner, In some examples, a first rider 30 may be viewing an advertisement screen 360 (discussed with respect to FIG. 11), while another rider 30 is viewing the home screen 340 and watching the vehicle 22 along a route. Although each rider 30 is interacting differently with the portable electronic device 300, all the electronic devices 300 on that vehicle 22 are synchronized is such a manner to transmit the same geolocation to the service provider 400. The service provider 400 recognizes that the portable devices 300 are from the same autonomous vehicle 22. In some examples, each rider 30 may have a seat on the autonomous vehicle 22, and each seat may have its own electronic device 200, 300. In such instances, the autonomous vehicle 22 may have an autonomous electronic device 300 that includes a driver application 230, and each rider 30 may have a rider electronic device 300 (part of the vehicle 22) having the rider application 330. The driver and/or rider application 230, 330 being used on the autonomous vehicles 22 may also display the current position of the vehicle 22, the weather, advertisements, etc.

Referring to FIGS. 5-7B, in some implementations, before the driver 20 starts his/her route, the driver 20 launches the driver application 230 on the portable electronic device 200, which displays a log-in screen 220 on the driver display 204. The log-in screen 220 prompts the driver 20 to enter specific vehicle information 221. The vehicle information 221 may include a vehicle driver identification number 221a, a vehicle number 221b, and the vehicle odometer 221c. The service provider 400 may request additional information from the driver 20. In addition, the vehicle driver 20 selects a route (e.g., Route A-F) from a predetermined route list 222 that the driver 20 may take. The driver 20 may input the information 221, 222 via several methods including, but not limited to, a drop down list, a combo list, and/or a list view. In some examples, a keyboard 224 allows the driver 20 to type the information 220, 222 that needs to be entered. The portable electronic device 200 then sends the vehicle information 221 to the service provider 400. In some examples, the service provider non-transitory memory 410 stores the vehicle information 22, ready for retrieval by a rider 30. When the driver 20 enters all the information 221, 222, the driver 20 logs into the driver application 230 by pressing or clicking a log-on button 226.

Referring to FIGS. 7A and 7B, once logged in, the driver device 200a displays a home screen 240 on the display 204. The home screen 240 includes an interactive map 234 that allows the driver 20 to view, in real-time the location of the vehicle 22 on the interactive map 234. As used herein, real-time may include a delay having a threshold time (e.g., 3 second, which may be the rate at which the information 216, 316 is updated to the service provider 400). A vehicle representation or icon 23 may represent each vehicle 22 on the interactive map 430. The vehicle icon 23 moves on the interactive map 430 as the vehicle 22 is moving in real-time. The vehicle icons 23 may have a color associated with the route that it is taking. For example, Route A may be green; Route B may be Red, etc. The driver 20 may zoom in and out of the interactive map 430, view the interactive map 430 in different views (e.g., heading-up view, north-up view, or three dimensional view). The driver 30 may adjust the brightness and/or colors of the interactive map 430. Other map features may also available.

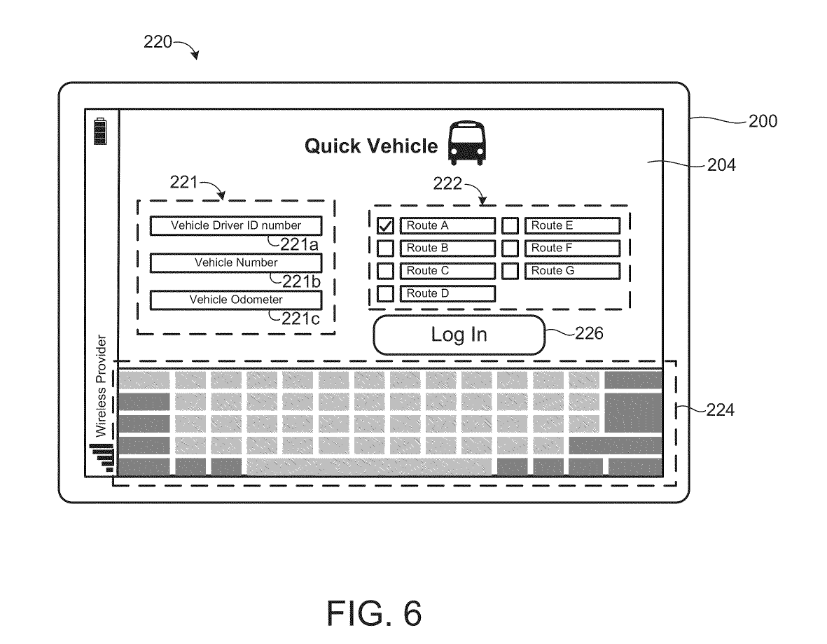

In some examples, on the interactive map 234 there is an overlay of information 241 containing static information buttons such as the name of the selected route 242 and/or toggle buttons (e.g., in-service/out-of-service 244 buttons) that allow the driver 20 to interact with the driver application 230. The information 241 may include displaying the name of the selected route (e.g., Route A from FIG. 6) in a route name field 242. The selected route 242 is the current route that the driver 20a is following. In addition to the selected route 242 being displayed, the interactive map 234 displays a representation 24 of the current route the driver 20 is following. In some examples, the interactive map 234 displays other vehicles 22 driving within the area and the routes 24b they are taking.

In some examples, a driver 20a drives a vehicle 22a along a route 24a. The driver 20a may select a status 244 of the vehicle 22a, such as whether the vehicle 22a is out of service 244a or in-service 244b. As shown, the vehicle status 244 is a toggle button, but may be other types of input such as, but not limited to, a switch or radio button. In some examples, when the driver 20a switches to out-of-service status 244a, the driver 20a may be prompted to enter a reason for being out-of-service. A keyboard 224 may be available for the driver 20a to type any information. For examples, the driver 20a may be out-of-service 224a because the driver 20a is taking a break or because the vehicle 22a is having mechanical problems. The driver 20a may indicate in an out-of-service field 245a the reason. The service provider 400 may decide whether to relate that information to the riders 30 via the rider application 330. When the vehicle 22a is out-of-service 224a, an out-of-service vehicle icon 25a is displayed on the interactive map 234 of the current driver 20a and other drivers 20. Additionally, when the driver 20a indicates that the vehicle 22a is out-of-service 224a, a timer 245c is shown indicating the duration of time the vehicle 22a has been out of service 224a.

The driver 20a may select to view the status and location 246 of other vehicles 22 that are within the interactive map 234 or may select to only view the vehicle 22a on the interactive map 234. Therefore, the driver 20a may toggle between a show all routes button 246a and show my route button 246b. As shown, the status and location 246 is a toggle button, but may be other types of input such as, but not limited to, a switch or radio button.

The information 241 overlaid on the interactive map 234 may include a rider count 248, which displays the number of riders 30 on the vehicle 22. In some examples, the service provider 400 provides the driver 20 with an interface 250 to update the rider count 248. The interface 250 may include a first indicator 252 (e.g., an arrow) for incrementing the rider count 248 and a second indicator 254 for decreasing the rider count 248. When the driver 20 touches the first indicator 252 the rider count 248 increases, and when the driver 20 touches the second indicator 254, the rider count 248 decreases. The interface 250 may include a sliding or feedback scale 256 where the driver 20 may move a needle 257 of the sliding scale to increase or decrease the rider count 248. In some examples, the rider count 248 is automatically updated when a rider 30 rides the vehicle 22. The rider count 248 may also automatically decrement when a rider 30 gets off the vehicle 22.

The driver 20 may use a third indicator 258 indicating whether the vehicle 22 is full and has a maximum number of riders 30. When the third indicator 258 indicates that the vehicle 22 is full, a display (not shown) located on the outside of the vehicle 22 and visible by potential riders 30 may also indicate that the vehicle 22 is full. Therefore, if the vehicle 22a fails to stop at a specific stop, the future riders 30 will know that the vehicle 22 did not stop because it is full. In some examples, when the vehicle 22 is empty, the driver 20 may indicate using a fourth indicator 260 that there are zero riders 30 on the vehicle 22.

When the driver 20 completes the route or shift, the driver 20 logs out of the driver application 230 by touching the logout button 227. The driver application 230 returns to the log in screen 220 (FIG. 6) and is ready for the next driver 20 to log in. In some examples, before logging out, the driver 20 may be prompted to enter the odometer value of the vehicle 22 at the end of the vehicle route or shift.

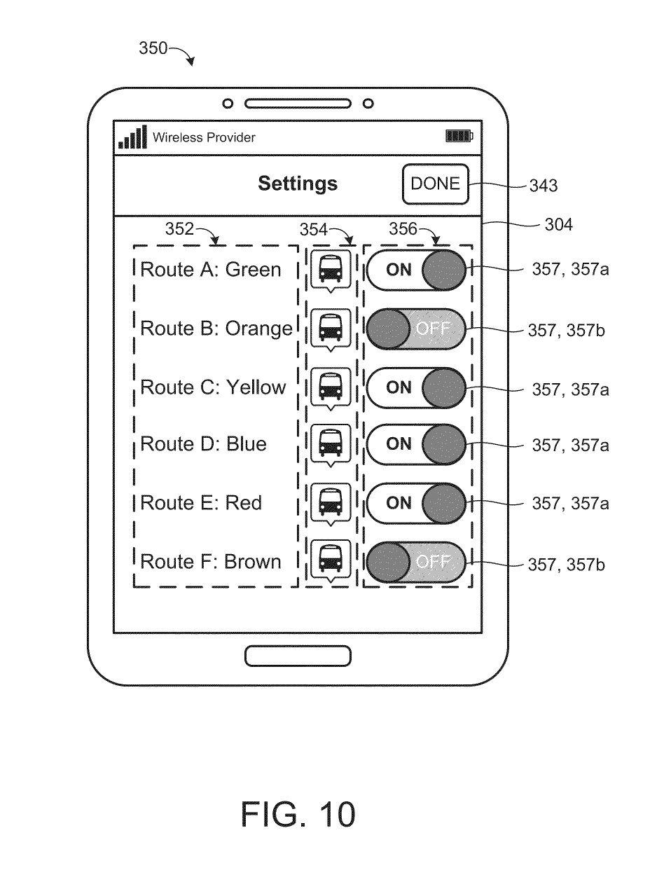

Referring to FIGS. 8-11, in some implementations, the rider 30 downloads the rider application 330 provided by the service provider 400. The rider 30 may download the application 330 on their smartphone or tablet 300a by either going to a website of the service provider 400 and requesting that the service provider 400 send the application 330 to their smartphone 300a, or by using their smartphone 300a to search for the application 330a on a search engine and directly download the application 330 on their smartphone 300a.

The user application 330 includes several features, such as geolocation services 332 (similar to the geolocation services described above with respect to the driver 20, which may include LBS), an interactive map 334, advertisements 440, non-transitory storage 310 (e.g., for a rider profile 312 and vehicle trip information 314), in some examples, the user application 330 may use the cloud storage 14. The geolocation services 332 provide a user location 332a, which in some examples, may be part of the rider profile 312. The rider application 230 may include other features not listed such as, traffic information and/or weather information. The rider application 330 gives the rider 30 several features including: a map 334 including user-selectable routes from a plurality of available routes; a passenger capacity status (e.g., FULL) of each vehicle 22 traveling along the selected route(s); one or more location-based merchant offers; proximate one or more drop-off locations along the selected route(s); and a displayed targeted advertisement 336 in response to selecting one of the location-based merchant offers.

Similar to the driver interactive map 234, the rider interactive map 334 allows the rider 30 to view, in real-time, the location of a vehicle 22 and an estimated time of arrival of the vehicle 22 to a vehicle stop 28 or a current location 33 of the rider 30, or at any other location specified by the rider 30. The vehicle icons 23a are displayed on the rider interactive map 334 and move on the interactive map 334 as the vehicle 22 is moving along a route in real-time. The vehicle icons 23a may have a different color associated with the vehicle icon 23a that is similar to a color of a route representation 24 displayed on the rider interactive map 334. For example, Route A may be green; Route B may be Red, etc. In some examples, the rider 30 (or the service provider 400) may customize the colors of the vehicle icons 23a and vehicle route representations 24. The rider 30 may zoom in and out of the interactive map 334, and view the interactive map 334 in different views (e.g., heading-up view, north-up view, or three dimensional view). The rider 30 may adjust the brightness and/or colors of the interactive map 334. Other map 334 features may also be available.

Referring to FIGS. 9-12, in some examples, when the rider 30 launches the application 330 on the electronic device 300, the rider 30 may view a rider home screen 340 displayed on a display 304 of the electronic device 300. The home screen 340 includes an interactive map 334. In some examples, the home screen 340 includes an information button 342. When a rider 30 touches or presses the information button 342, a settings screen 350 is displayed on the display 304 of the rider's electronic device 300. The settings screen 350 allows the rider 30 to select the routes he wants to be displayed on the home screen 340. For examples, if a user always takes the vehicles 22 on Routes A-C, the rider 30 may chose not to view Routes D-F. In some examples, the settings screen 350 provides the rider 30 with a list of the available routes 352 and, if available, the icons 23 representing the vehicles 22 driving on the routes. A sliding button 357 slides between an ON position 357a and an OFF position 357b and allows the rider 30 to select which routes from the route list 352 to be displayed on the interactive map 334. The on/off button may be a toggle button or any other button indicating a change from an on position 357a to and off positions 357b. In some examples, the settings screen 350 includes a list of the vehicle representations 23 on the interactive map 334 indicating the color of each vehicle representation 23. When a rider 30 completes the setting selections, the rider 30 touches or selects the done button 343 to return to the rider home screen 340, The rider 30 may have user name and sometimes a password associated with his rider profile 312. The rider 30 may update his username and or password by logging in on a website 430 of the service provider 400. A rider 30 may also change other settings to his rider profile 312 on the service provider website 430, which are incorporated in the profile associated with the rider application 330.

In some implementations, the service provider 400 sends the rider 30 targeted advertisements 336 from the available advertisements 443 stored in the advertisement database 442 of the service provider 400. The targeted advertisements 336 may be based on the rider profile 312, which may include a route history 312a, a travel time history 312b, predicted route 312c, predicted rider time 312d, consumption preferences 312e, and an offer retrieval history 312f. For example, if the rider 30 specified an interest in restaurants, the application 330 may provide information regarding restaurants within the vicinity of the vehicle route. The service provider 400 may track certain locations that the rider 30 frequents and establish a pattern of rider 30 behaviors. The pattern may be used to provide better advertisements to the rider 30.

The targeted advertisements 336 may be displayed on the user display 304 either as a banner 336a (e.g., on the top portion or on the bottom portion of the display), or as an icons 336b on the interactive map 334. The rider 30 may select or touch the targeted advertisement 336 and an advertisement screen 360 is displayed on the display 304 of the rider electronic device 300. The advertisement screen 360 provides more information relating to the targeted advertisement 336 that the rider 30 selected to view. As shown in FIG. 11, the advertisement screen 360 provides at least one of the following targeted advertisement 336 information: a name of the advertisement 361 (e.g., a restaurant name), hours of operations 362, an address 366, a link to get the directions 368, and an offer link 370 to redeem an offer. In some examples, one or more of the targeted advertisement information is user-selectable and provides more information when selected by the rider 30.

A conversion rate is an important rate in internet marketing because it is the rate of visits to a specific website who takes action to go beyond a casual content view or website visit, due to subtle or direct request from marketers, advertisers, and content creators. As an example, if a user visits a merchant's website and adds shopping items to a shopping cart, then later abandons the shopping cart, the merchant may market a special offer (free shipping or discount) to convert the customer from leaving the shopping cart to buying the items in the cart. Thus the conversion rate is the number of goal achievement over the visits. Optimizing conversion includes methods of creating webpages or landing pages (i.e., a first page of a website that appears when a user clicks on a link located on a different website) to increase the number of visitors that convert into customers. In some examples, the rider application 330 or the service provider 400 may track the advertisement conversion information 448 of a rider 30. Conversion information 448 includes conversion information of multiple riders 30 stored on the service provider non-transitory memory 410 (or on the cloud storage 14). The service provider 400 tracks and stores the time that a rider 30 shows interest in an advertisement (e.g., by viewing or by clicking on the advertisement 336 or any portions of the user selectable portion of the advertisement 336 as previously discussed) and the time of conversion. The time of conversion may be a time when the rider 30 views the advertisement 336, a time when the rider requests more information about the advertisement 336, or a time when the rider 30 makes a purchase through the advertisement 336. The service provider 400 may divide the conversion actions into levels, where a level one conversion occurs when the rider 30 makes a purchase through the advertisement 336, a level two conversion is when the rider requests more information about the advertisement 336, and level three conversion is when the rider 30 views the advertisement 336. In some examples, the service provider 400 may track a rider's predefined series of actions (e.g., view advertisement 336, then view location via a map) and consider them as a seperate conversion level. For example, referring back to FIG. 11, if a rider 30 selects the offer link 370 to redeem the offer, the rider application 330 or the service provider 400 tracks the conversion attempt. In addition the service provider 400 tracks the time and location 336a when the rider interacts with the advertisement screen 360. Such interaction includes the time each rider 30 selects any of the following targeted advertisement 336 information: a name of the advertisement 361 (e.g., a restaurant name), hours of operations 362, an address 366, a link to get the directions 368, an offer link 370 to redeem an offer, or any other information provided on the advertisement screen 360. Tracking such information (i.e., the conversion information 448 and the rider interactions with the targeted advertisements 336) is beneficial to learn the trends and habits of different riders 30, and consequently improving the quality of the targeted advertisement 336 and what targeted advertisements 336 are selected by the service provider 400 to be sent to the riders 30. Moreover, tracking conversion information 448 helps the service provider 400 to understand the market and how to effectively and efficiently target riders 30 with targeted advertisements 336. Each rider application 330 (or driver application 230) may be associated with a unique identifier for identifying the rider 30 and associating the rider 30 with a specific rider application 330. Thus, the service provider 400 tracks the unique rider identifier which combines the rider information (e.g., rider profile 312) and their conversion information 408. The ability to collect, save, and analyze the interaction of the rider 30 with the rider application 330 and the rider location 332a at the time of the interaction advantageously provides the service provider 400 with an improved understanding of the behavior of each rider 30.

In some implementations, the service provider 400 links a specific coupon or advertisement view with a specific rider 30, their location, and/or time of viewing the advertisement. Moreover, when the rider 30 acts on the offer, the service provider 400 can track the action that led to the conversion This helps the service provider 400 determine which offers are most effective, at what time they are most effective, and/or what location they are most effective. The service provider 400 may then learn the best location and/or time to provide data to a rider 30. Since the service provider 400 is capable of tracking the identity and or location of a rider 30 at the time the rider 30 views the advertisement 336 or at the time of the conversion such as at the time the user requests more information relating to the deal or at the time the user accepts or purchases the item offered by advertisement 336. The service provider 400 may charge a premium charge for advertisers wanting to advertise during a premium time or within a premium location. A premium time being a time that the service provider 400 identified to be a time having more conversions than other times.

Moreover, the service provider 400 may track if the conversion was performed at or near the advertisement location (e.g., restaurant, coffee shop, . . . ). For example, if the conversion occurs within a threshold distance from the advertisement location of the advertisement or offer, then the service provider 400 may determine that the offer is effective and may charge the offer provider a first fee rate for conversion due to the effectiveness of the offer. This allows the advertisers to only pay a higher advertisement fee rate when a rider 30 is converted based on a predefined set of parameters (e.g., location of user within the vicinity of the offer provider). The service provider 400 may allocate a fist, second, third, or more fee rates, each being based on different distances from the advertiser. In some examples, the rider application 330 or the service provider 400 checks if the rider 30 is within a geographical range of the establishment (e.g., advertisement provider) associated with advertisement, and the rider application 330 or the service provider 400 only tracks the conversion if such a condition is met. If the rider application 330 is tracking the conversion, then the service provider 400 retrieves the conversion information for use in selecting the advertisements to send to the rider 30.

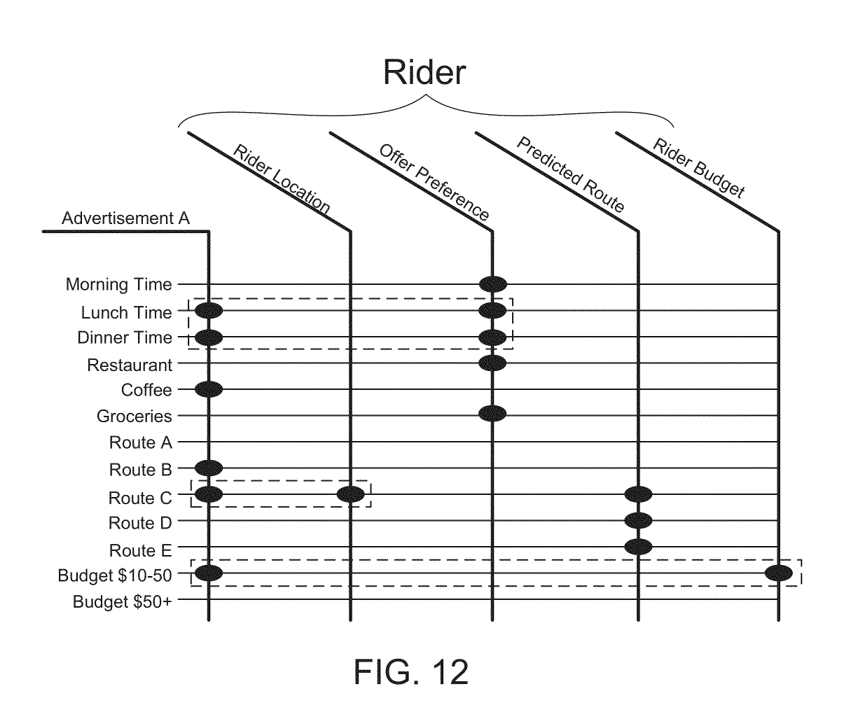

Referring to FIG. 12, in some implementations, the service provider 400 (i.e., the system data processor 402) determines which targeted advertisements 336 to send the rider 30 from the available advertisements 443 in the advertisement database 442. A rider 30 may have a rider profile 312 (FIG. 8) associated with a rider 30 using the rider electronic device 300. The rider profile 312 may include, but is not limited to, a rider route history 312a, a rider travel time history 312b, a predicted rider route 312c, a predicted ride time 312d, consumption preferences 312e, or an offer retrieval history 312f. The consumption preferences 312e may be attributes that the rider 30 has indicated that they like, such as an interest in restaurants only, or shopping, or groceries. The service provider 400 determines the advertisement information 336 based on a correlation between attributes of available advertisements 443 available in the advertisement database 442 and attributes of the rider profile 312. The attributes of available advertisements 443 may include an offer location 366, an offer time 362, an offer price, or an offer phone number. Some of the attributes of a rider profile 312 may include, but are not limited to, a rider location 332a, a rider time of travel, a rider budget, or a rider advertisement preference. A rider advertisement preferences may include the type of advertisements the rider 30 prefers to view (e.g., food and drink, beauty, health and fitness, home, etc.), the time and/or frequency that the advertisements may appear (e.g., between 8am and 8pm, or only when the application 230, 330 is being used).

The targeted advertisement information 336 includes advertisement representation data for overlaying on the interactive map 334 a representation of the advertisement 336 information along the vehicle route 24 or at least near a location of an establishment associated with the targeted advertisement information 336. The establishment may be located along at least the vehicle 22 route, a predicted rider route 312e for the rider electronic device 300, or a predicted destination of the rider electronic device 300 based on a riding history associated with a rider 30 using the rider electronic device 300.

Referring to FIG. 13-15, in some examples, the service provider 400 communicates to the rider data processor 302 or the driver data processor 202, map data 420 for displaying an interactive map 234, 344. The service provider 400 may communicate to the processors 202, 302 vehicle representation data 422 for overlaying on the interactive map 234, 334 a representation 24 of the vehicle route 214. In addition the service provider 400 may communicate vehicle representation data 422 for overlaying on the interactive map 234, 334 a representation 23 of the vehicle 22 or rider representation data 424 for overlaying on the interactive map 234, 334 a representation of the rider electronic device 33. In some examples, the service provider 400 sends to the driver data processor 202 or the rider data processor 302 historical data 412, which includes, but is not limited to, an average vehicle route time based on a past time of day, an average vehicle route time based on a current time of day, a rider route history based on a time of day, a rider retrieval and interaction history of offered advertisements, or a rider count history based on a time of day. The driver 20 or the rider 30 may use the historical data 412 to determine which route to take based on a time of day for example. The service provider 400 may send to the rider 30 an estimated time of arrival of a vehicle 22 at either the rider electronic device 300 along the vehicle route 24 or a designated vehicle stop 28 along a vehicle route 24.

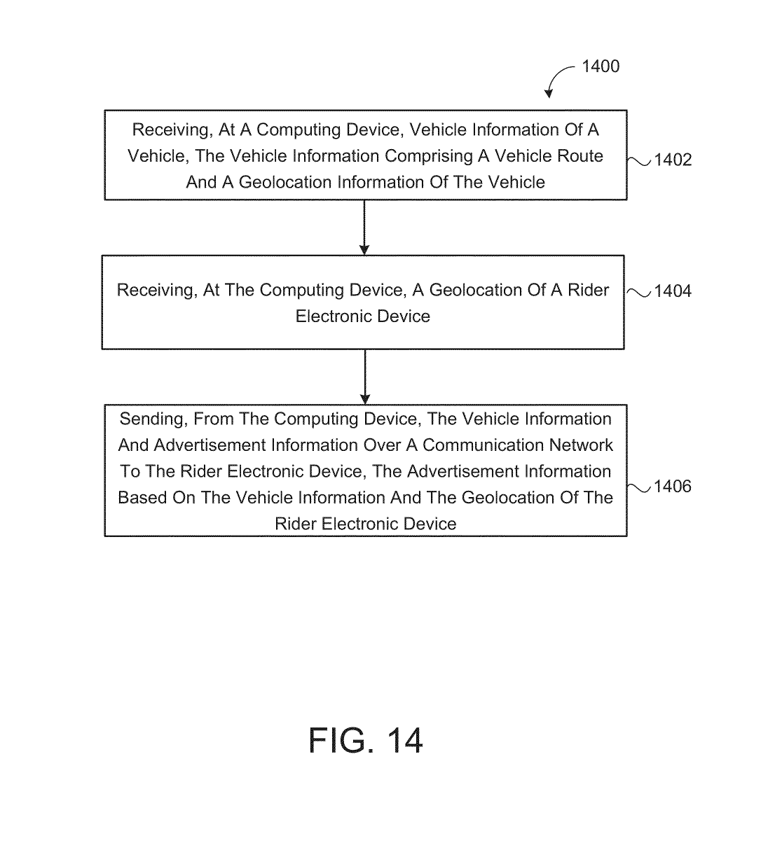

FIG. 14 illustrates an exemplary arrangement of operations for a method 1400 of communicating information between a vehicle driver 20 and a rider 30, using a service provider 400. The method 1400 includes receiving 1402, at a computing device 402, vehicle information 216 (e.g., vehicle route 214 and geolocation 232) of a vehicle 22. The method 1400 also includes receiving 1404, at the computing device 402, a geolocation 332 of a rider electronic device 300, and sending 1406, from the computing device 402, the vehicle information 216 and advertisement information 336 over a communication network 10 to the rider electronic device 300, the advertisement information 336 based on the vehicle information 216 and the geolocation 332 of the rider electronic device 300. The method 1400 may include receiving a rider profile 312 associated with a rider 30 using the rider electronic device 300 and determining the targeted advertisement information 336 based on a rider profile 312. The rider profile 312 may include transportation preferences. The method may include receiving 1408 rider interaction information with respect to the advertisement information 336. The method may include using the rider interaction information for determining future advertisement information 336.

The method 1400 may further include sending from the computing device 402 over a communication network 10 to the rider electronic device 300: map 334 data for displaying an interactive map 334; vehicle route 214 representation data for overlaying on the interactive map 334 a representation of the vehicle route 214; and vehicle 22 representation data for overlaying on the interactive map 334 a representation of the vehicle 22. Additionally or alternatively, the method 1400 may include sending from the computing device 402 over a communication network 10 to the rider electronic device 300: map 334 data for an interactive map 334; vehicle route 214 representation data for overlaying on the interactive map 334 a representation of the vehicle route 214; and rider 30 representation data for overlaying on the interactive map 334 a representation of the rider electronic device 300. Additionally or alternatively, the method 1400 may also include sending, from the computing device 402 over a communication network 10 to the rider electronic device 300, historical data 412 including at least one of an average vehicle route time based on a past time of day, an average vehicle route time based on a current time of day, a rider route history based on a time of day, a rider retrieval history of offered advertisements, or a rider count history based on a time of day.

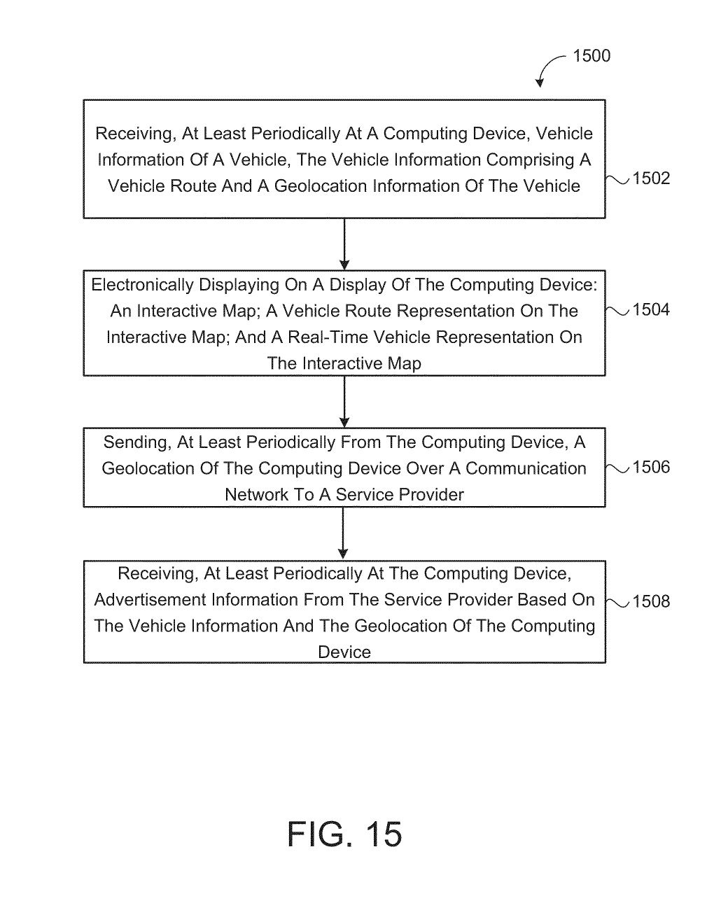

FIG. 15 illustrates an exemplary arrangement of operations for a method 1500 of communicating information between a vehicle driver 20 and a rider 30, using a service provider 400. The method 1500 includes receiving 1502, at least periodically at a computing device 402, vehicle information 216 (e.g., vehicle route 214 and a geolocation 232) of a vehicle 22. The method 1500 includes electronically displaying 1504 on a display of the computing device 402: an interactive map 234; a vehicle route 214 representation on the interactive map 234; and a real-time vehicle representation 23 on the interactive map 234. The method 1500 also includes sending 1506, at least periodically from the computing device 402, a geolocation 332 of the computing device 402 over a communication network 10 to a service provider 400; and receiving 1508, at least periodically at the computing device 402, advertisement information 336 from the service provider 400 based on the vehicle information 216 and the geolocation 332 of the computing device 402 and optionally the vehicle route 214. In some examples, the method 1500 further includes accessing a rider profile 312 of a rider 30 using the computing device 402.

Referring back to FIGS. 14 and 15, the rider profile 312 includes at least one of a rider route history 312a, a rider travel time history 312b, a predicted rider route 312c, a predicted ride time 312d, consumption preferences 312e, or an offer retrieval history 312f. In some examples, the targeted advertisement information 336 may be based on a correlation between attributes of available advertisement 443 stored on the advertisement database 442 and attributes of the rider profile 312. The attributes of available advertisement 443 offers may include at least one of an offer location 366, an offer time 362, an offer price, or an offer phone number; while the attributes of the rider profile 312 may include at least one of a rider location 332a, a rider time of travel, a rider budget, or a rider's advertisement preferences.

In some implementations, the vehicle information 216 further includes a service status 244, the service status 244 being an in-service status 244b or an out-of service status 224a. The vehicle information 216 may also include a rider count 248 of the vehicle 22, the rider count 248 being a number of riders 30 on the vehicle 22 or a rider status 258 indicating that the vehicle 22 has zero riders 260 or a maximum number of riders 262.

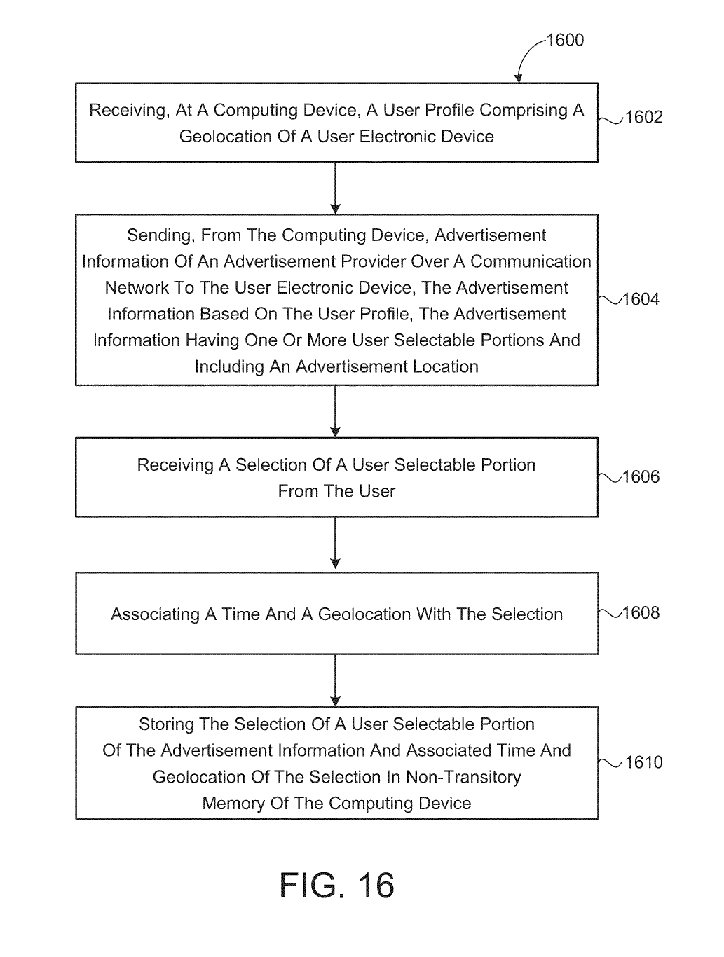

Referring to FIG. 16, a method 1600 includes receiving 1602, at a computing device 402, a user profile (e.g. driver 212 or rider 312) including a geolocation of a user 232a, 332a electronic device 200, 300. The method 1600 includes sending 1604, from a computing device 402, advertisement information 336 of an advertisement provider over a communication network 10 to the user electronic device 200, 300. The advertisement information 336 is based on the user profile 212, 312, and has one or more user selectable portions (e.g., a name 361 of the advertisement provider, hours of operation 362, an address 336, a uniform resource locator link to the address 368, an offer uniform resource locator link, or a purchase uniform resource locator link 370.) and includes an advertisement location 366. The method 1600 further includes receiving 1606 a selection of a user selectable portion from the user 20, 30 and associating 1608 a time and a geolocation with the selection. The method 1600 also includes storing 1610 the selectable portion of the advertisement information 336 and associated time and geolocation of the selection in non-transitory memory of the computing device 410.

In some examples, the user profile 212, 312 includes at least one of a user route history 312a, a user travel time history 312b, a predicted user travel route 312c, a predicted user travel time 312d, consumption preferences 312e, a user budget, user transportation preferences, or user advertisement preferences. The method 1600 further includes determining a distance between the geolocation associated with the selection of the user selectable portion and the advertisement location. When the distance is within a first threshold distance, the method includes charging the advertisement provider a first fee rate. When the distance is within a second threshold distance, the method includes charging the advertisement provider a second fee rate. Other fee rates may also be available and each has different requirements (e.g., distance or time).

In some implementations, the method 1600 includes sending, from the computing device 402, advertisement information 336 to the user electronic device 200, 300 based on the selection of a user selectable portion of the advertisement information 336 and associated time and geolocation of the selection.

Additionally or alternatively, the advertisement information 336 may include multiple user selectable portions, tracking a conversion of the user 20, 30 when the user 20, 30 selects multiple user selectable portions of the advertisement information 336. Additionally or alternatively, the method 1600 may further include tracking a conversion of a user 30 when the user 30 executed a purchase operation through the advertisement information 336 or accepts an offer of the advertisement information 336.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Implementations of the subject matter described in this specification can be implemented in a computing system that includes aback end component, e.g., as a data server, or that includes a middleware component, e.g., an application server, or that includes a front end component, e.g., a client computer having a graphical user interface or a web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A transit system comprising:
a system data processor in communication with a driver data processor of a driver electronic device and a rider data processor of a rider electronic device, the system data processor:
receiving vehicle information of a vehicle from the driver data processor, the vehicle information comprising a vehicle route and a geolocation of the vehicle;
receiving a geolocation of a rider electronic device from the rider data processor; and
sending the vehicle information and advertisement information over a communication network to the rider data processor, the advertisement information based on the vehicle information and the geolocation of the rider electronic device.

2. The transit system of claim 1, wherein the system data processor determines the advertisement information based on a rider profile associated with a rider using the rider electronic device, the rider profile comprising at least one of a rider route history, a rider travel time history, a predicted rider route, a predicted ride time, or consumption preferences.

3. The transit system of claim 2, wherein the system data processor determines the advertisement information based on a correlation between attributes of available advertisement offers and attributes of the rider profile.

4. The transit system of claim 3, wherein the attributes of available advertisement offers comprise at least one of an offer location, an offer time, an offer price, or an offer phone number.

5. The transit system of claim 3, wherein the attributes of the rider profile comprise at least one of a rider location, a rider time of travel, a rider budget, a rider advertisement preferences, or a rider transportation preferences.

6. The transit system of claim 1, wherein the vehicle information further comprises a service status, the service status being an in-service status or an out-of service status.

7. The transit system of claim 6, wherein if the service status is an out-of-service status, the system data processor further comprises:
receiving a message associated with the out-of service status; and
receiving an out-of service time indicating a duration of the out-of-service status.

8. The transit system of claim 1, wherein the vehicle information further comprises a rider count of the vehicle, the rider count being a number of riders on the vehicle or a rider status indicating that the vehicle has zero riders or a maximum number of riders.

9. The transit system of claim 1, wherein the system data processor communicates to the rider data processor or the driver data processor:
map data for displaying an interactive map;
vehicle route representation data for overlaying on the interactive map a representation of the vehicle route; and
at least one of vehicle representation data for overlaying on the interactive map a representation of the vehicle or rider representation data for overlaying on the interactive map a representation of the rider electronic device.

10. The transit system of claim 9, wherein the advertisement information comprises advertisement representation data for overlaying on the interactive map a representation of the advertisement information along the vehicle route or at least near a location of an establishment associated with the advertisement information.

11. The transit system of claim 10, wherein the establishment is located along at least the vehicle route, a predicted rider route for the rider electronic device, or a predicted destination of the rider electronic device based on a riding history associated with a rider using the rider electronic device.

12. The transit system of claim 1, wherein the system data processor sends over a communication network to the rider data processor historical data comprising at least one of an average vehicle route time based on a past time of day, an average vehicle route time based on a current time of day, a rider route history based on a time of day, a rider retrieval and interaction history of offered advertisements, or a rider count based on a time of day.

13. The transit system of claim 1, wherein the system data processor periodically receives the respective geolocation of the rider electronic device and the driver electronic device after a threshold period of time.

14. The transit system of claim 1, wherein the system data processor sends to the rider data processor an estimated time of arrival of the vehicle at either the rider electronic device along the vehicle route or a designated vehicle stop along the vehicle route.

15. A method comprising:
receiving, at a computing device, vehicle information of a vehicle, the vehicle information comprising a vehicle route and a geolocation of the vehicle;
receiving, at the computing device, transportation preference and a geolocation of a rider electronic device; and
sending, from the computing device, the vehicle information and advertisement information over a communication network to the rider electronic device, the advertisement information based on the vehicle information and the geolocation of the rider electronic device.

16. The method of claim 15, further comprising determining the advertisement information based on a rider profile associated with a rider using the rider electronic device, the rider profile comprising at least one of a rider route history, a rider travel time history, a predicted rider route, a predicted ride time, or consumption preferences.

17. The method of claim 16, further comprising determining the advertisement information based on a correlation between attributes of available advertisement offers and attributes of the rider profile.

18. The method of claim 17, wherein the attributes of available advertisement offers comprise at least one of an offer location, an offer time, an offer price, or an offer phone number.

19. The method of claim 17, wherein the attributes of the rider profile comprise at least one of a rider location, a rider time of travel, a rider budget, or a rider advertisement preferences.

20. The method of claim 15, wherein the vehicle information further comprises a service status, the service status being an in-service status or an out-of service status.

21. The method of claim 15, wherein the vehicle information further comprises a rider count of the vehicle, the rider count being a number of riders on the vehicle or a rider status indicating that the vehicle has zero riders or a maximum number of riders.

22. The method of claim 15, further comprising sending from the computing device over a communication network to the rider electronic device:
map data for displaying an interactive map;
vehicle route representation data for overlaying on the interactive map a representation of the vehicle route; and
vehicle representation data for overlaying on the interactive map a representation of the vehicle.

23. The method of claim 15, further comprising sending from the computing device over a communication network to the rider electronic device:
map data for an interactive map;
vehicle route representation data for overlaying on the interactive map a representation of the vehicle route; and
rider representation data for overlaying on the interactive map a representation of the rider electronic device.

24. The method of claim 15, further comprising sending, from the computing device over a communication network to the rider electronic device, historical data comprising at least one of an average vehicle route time based on a past time of day, an average vehicle route time based on a current time of day, a rider route history based on a time of day, a rider retrieval history of interaction with offered advertisements, or a rider count based on a time of day.

25. A method comprising:
receiving, at least periodically at a computing device, vehicle information of a vehicle, the vehicle information comprising a vehicle route and a geolocation information of the vehicle;
electronically displaying on a display of the computing device:
an interactive map;
a vehicle route representation on the interactive map; and
a real-time vehicle representation on the interactive map;
sending, at least periodically from the computing device, a geolocation of the computing device over a communication network to a service provider; and
receiving, at least periodically at the computing device, advertisement information from the service provider based on the vehicle information and the geolocation of the computing device.

26. The method of claim 25, further comprising accessing a rider profile of a rider using the computing device, the rider profile comprising at least one of a rider route history, a rider travel time history, a predicted rider route, a predicted ride time, or consumption preferences.

27. The method of claim 26, wherein the advertisement information is based on a correlation between attributes of available advertisement offers and attributes of the rider profile.

28. The method of claim 27, wherein the attributes of available advertisement offers comprise at least one of an offer location, an offer time, an offer price, or an offer phone number.

29. The method of claim 27, wherein the attributes of the rider profile comprise at least one of a rider location, a rider time of travel, a rider budget, or a rider advertisement preferences.

30. The method of claim 25, wherein the vehicle information further comprises a service status, the service status being an in-service status or an out-of service status.

31. The method of claim 25, wherein the vehicle information further comprises a rider count of the vehicle, the rider count being a number of riders on the vehicle or a rider status indicating that the vehicle has zero riders or a maximum number of riders.

32. A portable electronic device comprising;
a geolocation component determining a geolocation of the portable electronic device;
a data processor in communication with the geolocation component and configured to:
receive vehicle information comprising a vehicle route and a geolocation information of the vehicle;
send the geolocation of the portable electronic device over a communication network to a service provider; and
receiving advertisement information from the service provider based on the vehicle information and the geolocation of the portable electronic device; and
a display in communication with the data processor and displaying a user interface comprising:
a route selector;
an interactive map;
a route representation on the interactive map, the route representation corresponding to a route selected on the route selector;
a real-time device representation on the interactive map at location corresponding to the geolocation of the portable electronic device;
at least one real-time vehicle representation on the interactive map of any vehicles associated the selected route; and
an advertisement representation on the interactive map representative of the advertisement information.

33. The portable electronic device of claim 32, wherein the advertisement representation is overlain on the interactive map along the selected vehicle route or at least near a location of an establishment associated with the advertisement information.

34. The portable electronic device of claim 33, wherein the establishment is located along at least the vehicle route, a predicted rider route for the rider electronic device, or a predicted destination of the rider electronic device based on a riding history associated with a rider using the rider electronic device.

35. The portable electronic device of claim 32, wherein the data processor accesses a rider profile of a rider using the portable electronic device, the rider profile comprising at least one of a rider route history, a rider travel time history, a predicted rider route, a predicted ride time, or consumption preferences.

36. The portable electronic device of claim 35, wherein the advertisement information is based on a correlation between attributes of available advertisement offers and attributes of the rider profile.

37. The portable electronic device of claim 36, wherein the attributes of available advertisement offers comprise at least one of an offer location, an offer time, an offer price, or an offer phone number.

38. The portable electronic device of claim 36, wherein the attributes of the rider profile comprise at least one of a rider location, a rider time of travel, a rider budget, or a rider advertisement preferences.

39. The portable electronic device of claim 32, wherein the vehicle information further comprises a service status, the service status being an in-service status or an out-of service status.

40. The portable electronic device of claim 32, wherein the vehicle information further comprises a rider count of the vehicle, the rider count being a number of riders on the vehicle or a rider status indicating that the vehicle has zero riders or a maximum number of riders.

41. A transit system comprising:
at least one driver electronic device and a rider electronic device, each electronic device comprising:
a data processor;
a geolocation component in communication with the data processor and determining a geolocation of the electronic device; and
a display in communication with the data processor and displaying a user interface comprising:
a route selector;
an interactive map;
a route representation on the interactive map, the route representation corresponding to a route selected on the route selector; and
a real-time device representation on the interactive map at location corresponding to the geolocation of the electronic device;
a service provider device comprising a data processor in communication with the data processor of the driver electronic device and the data processor of the rider electronic device, the data processor of the service provider device:
receiving vehicle information of a vehicle from the driver data processor, the vehicle information comprising a vehicle route and a geolocation of the vehicle;
receiving a geolocation of the rider electronic device from the rider data processor; and
sending the vehicle information and advertisement information over a communication network to the rider data processor, the advertisement information based on the vehicle information and the geolocation of the rider electronic device.

42. The transit system of claim 41, wherein the display of each electronic device displays at least one real-time vehicle representation on the interactive map of any vehicles associated with any driver electronic devices on the selected route.

43. The transit system of claim 41, wherein the data processor of the service provider determines the advertisement information based on a rider profile associated with a rider using the rider electronic device, the rider profile comprising at least one of a rider route history, a rider travel time history, a predicted rider route, a predicted ride time, or consumption preferences.

44. The transit system of claim 43, wherein the data processor of the service provider determines the advertisement information based on a correlation between attributes of available advertisement offers and attributes of the rider profile.

45. The transit system of claim 44, wherein the attributes of available advertisement offers comprise at least one of an offer location, an offer time, an offer price, or an offer phone number.

46. The transit system of claim 44, wherein the attributes of the rider profile comprise at least one of a rider location, a rider time of travel, a rider budget, or a rider advertisement preferences or transportation preferences.

47. The transit system of claim 41, wherein the advertisement information comprises advertisement representation data for overlaying on the interactive map a representation of the advertisement information along the vehicle route or at least near a location of an establishment associated with the advertisement information.

48. The transit system of claim 47, wherein the establishment is located along at least the vehicle route, a predicted rider route for the rider electronic device, or a predicted destination of the rider electronic device based on a riding history associated with a rider using the rider electronic device.

49. A method comprising:
receiving, at a computing device, a user profile comprising a geolocation of a user electronic device;
sending, from the computing device, advertisement information of an advertisement provider over a communication network to the user electronic device, advertisement information based on the user profile, the advertisement information having one or more user selectable portions and including an advertisement location;
receiving a selection of a user selectable portion from the user;
associating a time and a geolocation with the selection; and
storing the selection of a user selectable portion of the advertisement information and associated time and geolocation of the selection in non-transitory memory of the computing device.

50. The method of claim 49, wherein the user profile further comprises at least one of a user route history, a user travel time history, a predicted user travel route, a predicted user travel time, consumption preferences, a user budget, user transportation preferences, or user advertisement preferences.

51. The method of claim 49, further comprising:
determining a distance between the geolocation associated with the selection of the user selectable portion and the advertisement location;
when the distance is within a first threshold distance, charging the advertisement provider a first fee rate; and
when the distance is within a second threshold distance, charging the advertisement provider a second fee rate.

52. The method of claim 49, further comprising sending from the computing device advertisement information to the user electronic device based on the selection of a user selectable portion of the advertisement information and associated time and geolocation of the selection.

53. The method of claim 49, wherein the one or more user selectable portions comprise at least one of a name of the advertisement provider, hours of operation, an address, a uniform resource locator link to the address, an offer uniform resource locator link, or a purchase uniform resource locator link.

54. The method of claim 53, further comprising, when the advertisement information comprises multiple user selectable portions, tracking a conversion of the user when the user selects multiple user selectable portions of the advertisement information.

55. The method of claim 53, further comprising tracking a conversion of a user when the user executes a purchase operation through the advertisement information or accepts an offer of the advertisement information.
